(19) United States
(12) Patent Application Publication
(10) Pub. No.: US 2011/0170778 A1
(43) Pub. Date: Jul. 14, 2011

(54) ENHANCED GAMMA IMAGING DEVICE FOR THE PRECISE SPATIAL LOCALISATION OF IRRADIANT SOURCES

(75) Inventors: Christophe Le Goaller, Meylan (FR); Charly Mahe, Saint Paul Trois Chateaux (FR)

(73) Assignee: COMMISSARIAT A L'ENERGIE ATOMIQUE ET AUX ENG ALT., Paris (FR)

(21) Appl. No.: 12/996,811

(22) PCT Filed: Jun. 15, 2009
(86) PCT No.: PCT/EP2009/057327

§ 371 Date: Mar. 31, 2011

(30) Foreign Application Priority Data
Jun. 16, 2008 (FR) 0853959

(51) Int. Cl. G06K 9/34; G01T 1/164

(52) U.S. Cl. 382/180; 250/363.1

(57) ABSTRACT

A gamma imaging device including a gamma camera capturing a gamma radiation image, referred to as a gamma image, of an observed scene, and including a front face and having an axis of sight, and an auxiliary camera capturing a visible light image of the observed scene. The auxiliary camera is situated upstream from the front face of the gamma camera and has an optical axis substantially merged with the axis of sight of the gamma camera such that the visible light image and the gamma image are captured substantially simultaneously with the same direction of sight.

### FIELD OF THE INVENTION

The invention relates to an enhanced gamma imaging device for the precise spatial localisation of irradiant sources, making it particularly suitable for the preparation of procedures in irradiant environments such as maintenance, dismantling or inspection operations. Such a device incorporates a gamma camera.

### STATE OF THE RELATED ART

Since the early 1990s, the applicant has developed a relatively compact gamma imaging device called ALADIN for localising irradiant sources emitting gamma radiation. Such an imaging device outputs a final image formed from a gamma image wherein at least one irradiant source is represented as a false-coloured spot overlaid on a visible or quasi-visible light image of the observed scene. The image of the irradiant source consists of an intensity distribution of the gamma radiation received by the gamma camera, whereas the visible or quasi-visible light image of the observed scene is acquired either by the gamma camera itself or by an auxiliary visible or quasi-visible light, black and white or colour-sensitive camera interacting with the gamma camera. Such a gamma imaging device outputs information on the localisation of any irradiant sources observed by the device. The quasi-visible light image may be an infrared image.

FIG. 1 shows a sectional view of an example of such a gamma imaging device. It comprises a gamma camera 1 comprising, in cascade, a pinhole collimator 2, a scintillator 3, a set of photonic components 4 incorporating, in cascade, an image intensifier tube, a fibre-optic reducer and a CCD detector. The photonic components are not shown. The scintillator 3 and the set of photonic components 4 are placed in a shell 5 shielded from gamma radiation γ from at least one irradiant source 8 observed by the gamma imaging device. In an alternative embodiment, the pinhole collimator 2 could be replaced by an encoded mask aperture (not shown). Encoded mask gamma cameras have a greater sensitivity than pinhole gamma cameras.

The scintillator 3 converts the gamma radiation Rγ received in light signals applied to the set of photonic components 4, which converts the light signals received into electrical signals suitable for processing.

The gamma imaging device may further comprise, attached to the gamma camera 1, a visible or near-visible light-sensitive auxiliary camera 6, wherein the optical axis x1 is offset from the axis of sight x2 of the gamma camera 1 while remaining substantially parallel with the axis of sight x2 of the gamma camera 1. This configuration offers the advantage of being able to acquire the visible or quasi-visible light image, hereinafter referred to as the visible light image, and the gamma radiation giving rise to the gamma image simultaneously. However, the drawback thereof is that it is necessary to correct the parallax on the visible light image such that the corrected visible light image appears to have been acquired with the direction of sight as the gamma image.

A further configuration is described in the patent application [1] the references whereof are at the end of the description, the parallax correction is performed by a mirror sighting system at 45°, enabling the auxiliary camera to observe a visual field wherein the axis of sight merges substantially with that of the gamma camera. This configuration involves a relatively complex assembly of the sighting system which needs to have a perfectly adjusted position.

It can be envisaged that the gamma camera 1 further comprises, upstream from the collimator 2, a shutter 7. When the collimator 2 is of the pinhole type, the shutter 7 is suitable, for adopting two positions: an open position and a closed position. When the shutter 7 is in the open position, the gamma camera 1 can acquire the visible light image of the observed scene and when the shutter 7 is in the closed position, the gamma camera 1 can acquire the gamma radiation and thus the gamma image. The same acquisition channel may be used. However, the two images cannot be simultaneous since it is necessary to switch the shutter 7 from one position to another.

The gamma image is a generally 8-bit (256 grey scale) encoded digital image. It is refreshed according to an acquisition rate varying between tens of milliseconds (real-time rate) and seconds (so-called quasi-real-time rate). It is possible to accumulate a number of gamma images to arrive at a 16-bit encoded gamma image. The number of images used is frequently between hundreds in the case of high irradiation and thousands in the case of low irradiation.

When a gamma image is acquired, the shutter 7 is closed and it is thus not possible to acquire a visible image simultaneously.

This image enables the detection of the presence of an irradiant source but not the precise spatial localisation thereof. Experience demonstrates that, with such a gamma camera, the detection of an irradiant source producing a 10 μGy/hr dose rate is ensured in an overall environment of 0.1 μGy/hr. This gamma image is obtained after processing the signals output by the set of photonic components, these processing operations possibly consisting of low-pass filtering and colouring.

In this configuration, the gamma image and the visible light image is perfectly aligned since they were captured with the same axis. However, they are not taken simultaneously, since they are derived from different shutter states. The final image is obtained from retrospective processing.

The shutter 7 with the two positions thereof cannot be used with the pinhole collimator gamma camera 1 since, with an encoded mask aperture, no image suitable for processing can be acquired in the open position. With an encoded mask aperture, a closed fixed shutter is used. With the encoded mask gamma camera, an auxiliary camera attached to the gamma camera is necessarily used to obtain the visible light image and the overlay of the gamma image and the visible light image is performed approximately after laboratory calibration. Furthermore, it is necessary to determine the distance between the gamma imaging device and the irradiant source, representing a significant constraint.

Documents [2] and [3], the references whereof are given at the end of the description, describe the operation and performances of pinhole collimator gamma imaging devices. The documents referenced [4] and [5] describe the operation and performances of encoded mask aperture gamma imaging devices. The patent application referenced [6] describes additional instrumentation for the gamma imaging device for enhancing the precision of the measurements made. The documents referenced [7] and [8] demonstrate how the scintillator and the photonic components may be replaced by a solid detector consisting of a machine-readable hybrid pixelated semiconductor. It may also consist of an elementary semiconductor matrix. The solid semiconductor detector converts the gamma radiation received directly into electrical signals. The semiconductor material may for example be silicon or cadmium telluride. In these two cases, the gamma camera cannot acquire visible light images and the auxiliary camera needs to be provided.

The gamma imaging device may further include a collimated gamma spectrometry probe comprising a gamma spectrometry detector positioned downstream from a gamma spectrometry collimator. The probe is rigidly connected to the gamma camera or the auxiliary camera. FIG. 1 does not show a collimated gamma spectrometry probe. The collimated gamma spectrometry probe enables energy measurements of the gamma radiation received and counting of the number thereof for a predetermined period, enabling the identification and quantification of the radioelements causing the gamma irradiation.

### DESCRIPTION OF THE INVENTION

The aim of the present invention is precisely that of proposing a gamma imaging device which does not have the drawbacks mentioned above, i.e.: need for parallax processing between the gamma image and the visible light image and obtaining the final image in offline mode.

To achieve this, the present invention relates to a gamma imaging device comprising:
a pinhole collimator gamma camera for acquiring a gamma radiation image, referred to as a gamma image, of an observed scene, provided with a front face and having an axis of sight;
an auxiliary camera for capturing a visible light image of the observed scene. According to the invention, the auxiliary camera is situated upstream from the front face of the gamma camera, and has an optical axis substantially merged with the axis of sight of the gamma camera such that the visible light image and the gamma image are captured substantially simultaneously with the same direction of sight.

The gamma imaging device may further comprise acquisition and processing means of signals output by the auxiliary camera and by the gamma camera for supplying, substantially in real time in relation to the capture, to display means, a final image of the observed scene which is an overlay of the visible light image and a representation of one or a plurality of irradiant sources situated in the observed scene and detected on the captured gamma image.

The representation is a coloured spot or an outline.

The auxiliary camera may be mounted on a supporting member, which is attached to the front of the gamma camera, particularly by screwing or by fitting.

The supporting member may be substantially a revolving cylinder and have an outer diameter greater than the outer diameter of the gamma camera to enable screwing or fitting. The gamma imaging device equipped with the auxiliary camera thus remains very compact.

Advantageously, the supporting member is made of a material opaque to visible light, to prevent said light from entering inside the gamma camera.

The supporting member is made of a material having a sufficiently low density, such as aluminium or a plastic, to attenuate the gamma radiation from the observed scene as little as possible.

The gamma imaging device may further comprise a collimated spectrometry probe rigidly connected to the supporting member and/or the gamma camera.

The gamma camera may further comprise, at the front face, an optionally removable shutter for producing gamma images when it is closed or visible images when it is open.

The gamma camera may be suitable for providing a visible light image of the observed scene. The visible light images from the gamma camera and the auxiliary camera are realigned.

The present invention also relates to a method for localising one or a plurality of irradiant sources present in a scene observed by a characterised gamma imaging device. It comprises steps for:
substantially simultaneous capture of a visible light image of the observed scene and gamma radiation from the irradiant sources;
formation of a gamma image of the observed scene using the gamma radiation captured;
processing of the gamma image giving rise to a representation of the irradiant sources with:
   division of the gamma image into one or a plurality of basic zones consisting of pixels,
   allocation of at least one indicator to each basic zone, this indicator conveying a basic zone pixel signal quantity;
   determination among the basic zones of one or a plurality of effective zones for which the indicator is greater than a threshold;
   optionally, cropping of the effective zones to show an outline of the effective zones, the effective zones or the outline of the effective zones giving the representation.
overlay of the visible light image and the representation to obtain a final image of the observed scene;
display of the final image.

In a further embodiment, the processing may further comprise:
determination among the basic zones of one or a plurality of neutral zones for which the indicator is less than the threshold;
allocation of a zero level to the neutral zone pixels;
thresholding at one or a plurality of thresholds and colouring on the basis of the thresholds of the neutral and effective zones, the neutral and effective zones after thresholding and colouring giving the representation.

The thresholding may be preceded by filtering so as to eliminate interference.

The indicator mentioned above may be a mean level of pixels of the basic zones for example.

### BRIEF DESCRIPTION OF THE FIGURES

The present invention will be understood more clearly on reading the description of examples of embodiments given merely for indicative and not limitative purposes, with reference to the appended figures wherein:

FIG. 1 described above is a sectional view of a known gamma imaging device;

FIGS. 2A, 2C, 2D are three-dimensional views of examples of gamma imaging devices according to the invention during the assembly thereof, FIG. 2B showing an encoded mask gamma imaging device;

FIG. 3 illustrates a sectional view of an example of a gamma imaging device according to the invention;

FIGS. 4A to 4C show various steps of examples of method for localising one or a plurality of irradiant sources present in a scene observed by a gamma imaging device according to the invention.

Identical, similar or equivalent parts of the various figures bear the same numeric references so as to facilitate the transition from one figure to another.

The various parts represented in the figures are not necessarily according to a uniform scale, to render the figures easier to read.

### DETAILED DESCRIPTION OF PARTICULAR EMBODIMENTS

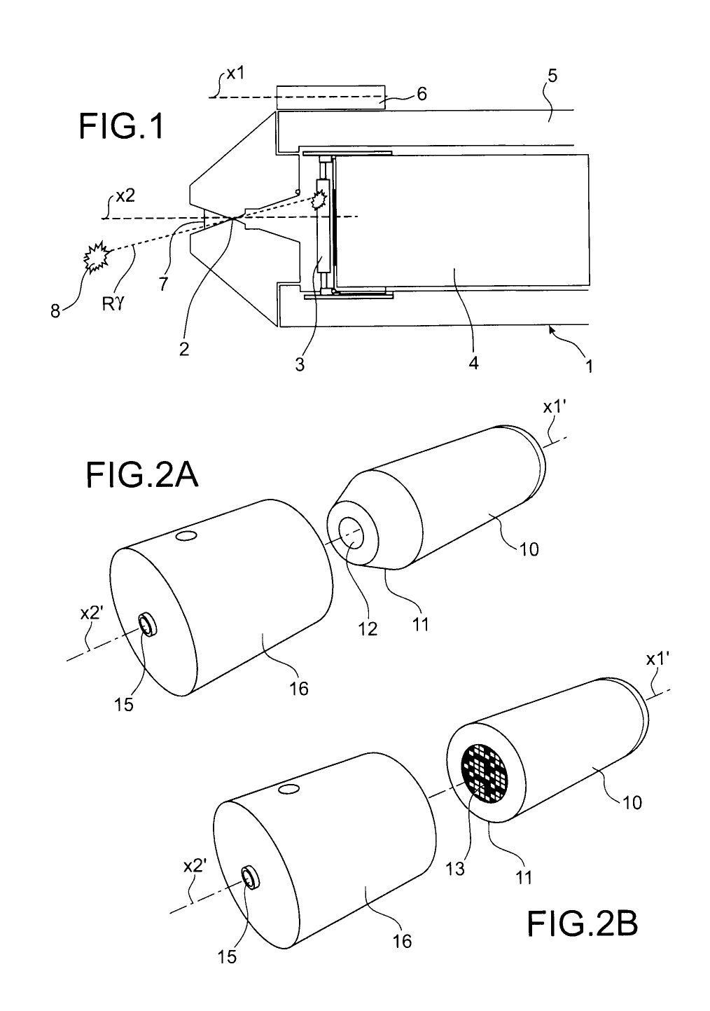

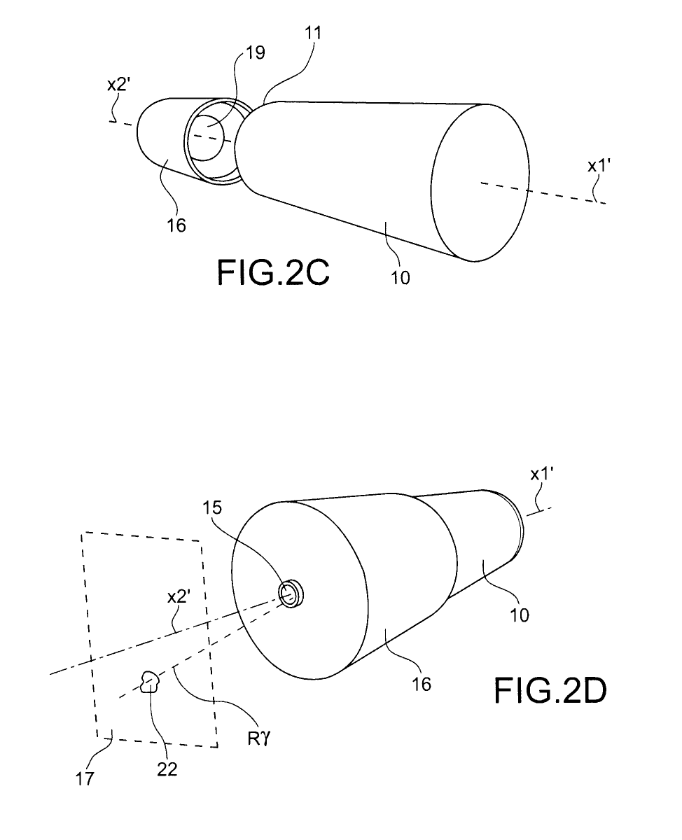

FIGS. 2A, 2C, 2D showing various views of a gamma imaging device according to the invention in the process of being assembled will now be examined. It comprises a conventional gamma camera 10 which may be very similar to that described in FIG. 1 with the reference 1. It consists of a pinhole collimator gamma camera as in FIG. 2A. In FIG. 2B, the gamma camera is of the encoded mask type, this figure is not part of the invention. The gamma camera 10 has a front face 11 at the pinhole 12 end. In FIGS. 2C, 2D, the front face of the pinhole end gamma camera is not shown. The gamma camera 10 is intended to acquire a gamma image of an observed scene 17.

The gamma camera 10 has an axis of sight x1′. The gamma imaging device further comprises an auxiliary camera 15 sensitive to visible or near-visible light, for example infrared. The auxiliary camera 15 is preferably a digital camera. The auxiliary camera 15 comprises an optical axis x2′. The auxiliary camera 15 is rigidly connected to the front face 11 of the gamma camera 10, the optical axis x2′ thereof merging substantially with the axis of sight x1′ of the gamma camera 10. The gamma camera 10 and the auxiliary camera 15 view the observed scene 17 with the same direction of sight, the auxiliary camera 15 being upstream from the gamma camera 10 in relation to the observed scene 17.

Most commercial gamma cameras used in the field of medical imaging comprise a collimator having parallel channels, or an encoded mask collimator. This configuration provides superior signal collection. The pinhole collimators make it possible to obtain, via the gamma camera, a visible light image suitable for processing, although of mediocre quality. It is thus possible, as described above, with the same imaging device, to switch from a visible light mode to a gamma radiation mode using a removable shutter, the visible light image being obtained with the shutter is open and the gamma radiation image being obtained with the shutter closed. However, it is impossible to obtain a visible light image and a gamma radiation image simultaneously. In the event of a significant quantity of light reaching the gamma camera when the shutter is open, this may create glare and afterglow phenomena on the detector. It is thus desirable to minimise the number of images produced in visible mode by the gamma camera.

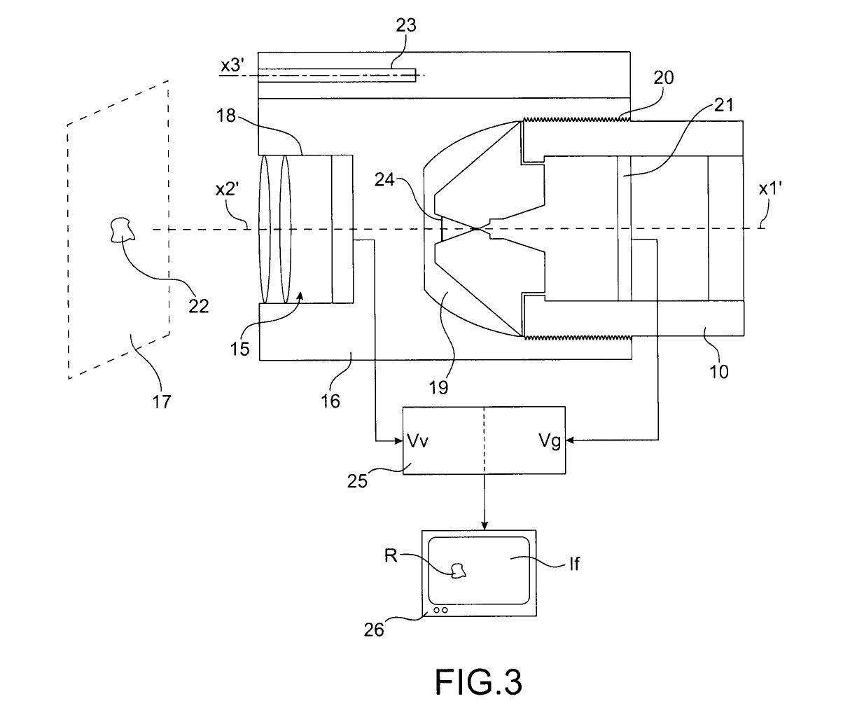

The auxiliary camera 15 is rigidly connected to the gamma camera 10 via a supporting member 16 attached to the gamma camera 10 at the end of the front face 11 thereof. The auxiliary camera 15 is housed in the supporting member 16. The auxiliary camera 15 is chosen to be compact. The gamma camera 10 is fitted in the supporting member 16 or is screwed onto the supporting member 16. The supporting member 16 is made of a material having as low a density as possible so as to attenuate the gamma radiation Rγ from one or a plurality of irradiant sources 22 situated in the observed scene 17 to the minimum level and is directed towards the gamma camera 10. Suitable materials are, for example, aluminium or plastic. The same supporting member 16 may be used regardless of the type of gamma camera 10. In other words, the supporting member 16 is compatible with a plurality of gamma camera 10 models. The pinhole gamma camera 10 comprises on the front face a substantially conical collimator whereas the front face of an encoded mask gamma camera 10 is substantially plane. The supporting member 16 takes the form for example of a revolving cylinder comprising at one end a housing 18 for the auxiliary camera 15 and at the other end a compartment 19 wherein the front face 11 of the gamma camera 10 is fitted. Reference is also made to FIG. 3. A screw thread 20 may be provided for screwing onto the gamma camera 10 as illustrated in FIG. 3. The lens of the gamma camera 15 may be level with the supporting member 16. The supporting member 16 has an outer diameter which is greater than that of the gamma camera 10 to enable fitting. The aim is that of not increasing the diameter of the gamma imaging device excessively in relation to that of the gamma camera alone. However, once the supporting member 16 is attached to the gamma camera 10, the gamma imaging device has an increased length in relation to that of the gamma camera alone.

The supporting member 16 is opaque to visible or near-visible light hitting the auxiliary camera 15 and is attached sufficiently tightly to the gamma camera 10 to prevent said light from entering the gamma camera 10. This protects the scintillator and the image intensifier of the gamma camera and increases the service life thereof.

The detector 21 of the gamma camera 10, whether it is a CCD or a solid semiconductor detector, comprises a plurality of sensitive elements or pixels each outputting an electrical signal dependent on a distribution of gamma radiation Rγ emitted by one or a plurality of irradiant sources 22 situated in the observed scene 17. The signals from the detector 21 are both dependent on the position thereof on the surface of the detector 21 and dependent on the gamma energy at the source of the interactions in the scintillator if present or in the detector per se when it is a solid semiconductor detector.

The gamma imaging device according to the invention may further comprise a collimated gamma spectrometry probe 23 rigidly connected to the supporting member 16 and/or the gamma camera 10. The gamma spectrometry probe 17 is oriented along an axis x3′ which is substantially parallel with the common axis x1′, x2′ of the gamma camera 10 and the visible camera 15 but is offset therefrom.

Furthermore, it is possible to envisage an optionally removable shutter 24 on the front face of the gamma camera 10. This shutter makes it produce gamma images when it is closed or visible images when it is open. The use of the shutter 24 enables the preliminary calibration of the fields of vision of the camera in gamma mode and in visible mode.

Parallel beam collimator gamma cameras also exist.

Gamma cameras using a parallel beam collimator are not suitable for localising irradiant sources situated at long distances, for example more than 1 m from the collimator. This type of camera is preferentially in contact or pseudo-contact, the distance between the collimator and the source generally being between a few centimetres and tens of centimetres.

Gamma cameras using an encoded mask collimator may be suitable for observing irradiant sources situated at greater distances, but they pose the problem of artifact creation when the sources are situated in the vicinity of the field observed. The inventors thus observed that when the irradiant sources are situated at variable distances in relation to the gamma camera, said distances varying from tens of centimetres to tens of metres, at any point of the field observed, including in the vicinity of the limits of the field, or outside the field, the pinhole configuration was preferable in relation to an encoded mask configuration or parallel beam collimator. A pinhole configuration makes it possible to obtain an optical system having an infinite field depth, i.e. the irradiant sources will appear clearly, regardless of the distance thereof in relation to the gamma imaging device, without requiring particular focussing. Such a configuration is thus very advantageous.

Furthermore, the use of a pinhole gamma camera does not require the use of complex decoding algorithms.

The gamma imaging device according to the invention further comprises a display device 26 and acquisition and processing means 25 of electrical signals output by the auxiliary camera 15 and by the gamma camera 10. These acquisition and processing means 25 comprise two acquisition and processing channels, one referred to as the gamma channel Vg and the other referred to as the visible channel Vv which interact to output on the display device 26 a final image If which is a visible light image of a scene captured by the visible camera 15 at a given time along a direction of sight. The final image If shows an overlay of a representation R of one or a plurality of irradiant sources 22 captured by the gamma camera 10 substantially at the given time and with substantially the same direction of sight. The directions of sight correspond to the axes x1′, x2′. The optical axes x1′, x2′ of the two cameras are merged in the figures. The fields of vision of the cameras may be different, however, it is preferable for the field of vision of the visible camera to be greater.

The acquisition and processing means 25 include a computerised image processing system which may be conventional.

At least two processing modes may be used, the first being referred to as the overlay mode and the second guide mode, a third mode referred to as composite mode may partly combine both modes. In the processing modes, the visible light image Iv and the gamma radiation forming the basis of the gamma image Ig are captured substantially at the same time, and they correspond to the same observed scene. These images each transit via a channel Vv, Vg respectively.

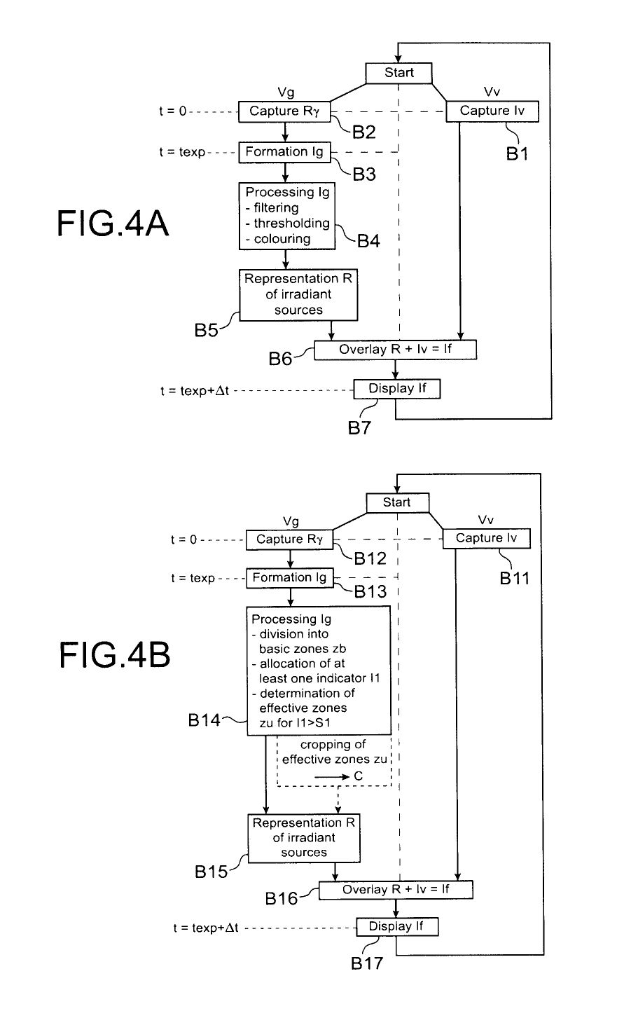

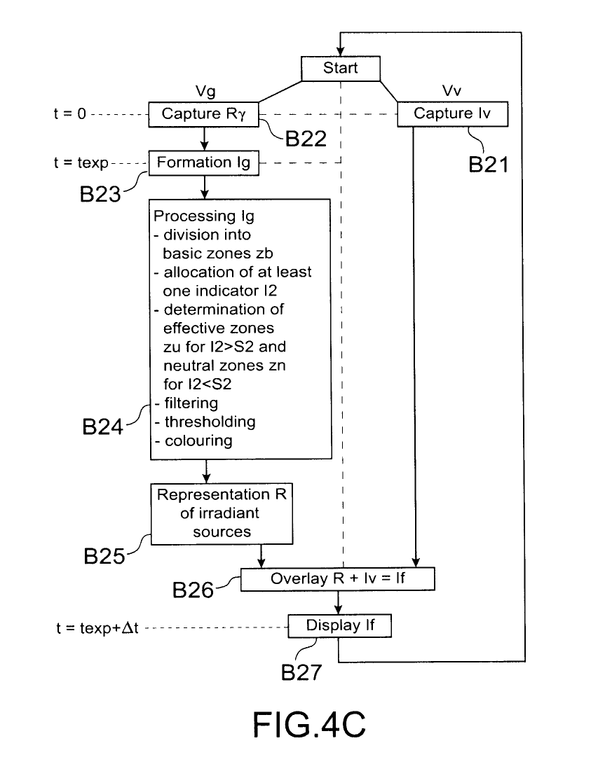

The overlay mode will be described first with reference to FIG. 4A.

At the start time (t=0), the auxiliary camera captures a visible light image Iv (block B1) of the observed scene and substantially simultaneously the gamma camera captures a gamma radiation Rγ (block B2) from one or a plurality of irradiant sources situated in the same observed scene.

This gamma radiation Rγ will serve to form a gamma image Ig (block B3), but this gamma image Ig is only formed after a time texp corresponding to the detector exposure time. This exposure time texp varies, for example, between 0.04 seconds and 5 seconds, preferentially between 0.8 seconds and slightly more than 2 seconds.

Once the gamma image Ig is formed on the detector, it is processed (block B4), the processing may comprise at least one low-pass filtering to eliminate noise. It further comprises thresholding using one or a plurality of thresholds, colouring to assign a different colour to the pixels in the gamma image Ig according to the level thereof after thresholding, the colouring is dependent on the thresholds. Further processing, currently known to those skilled in the art, may be envisaged. The processing gives rise to a representation R of the irradiant sources (block B5). The irradiant sources correspond to coloured spots in the representation R.

The representation R is overlaid on the visible light image Iv (block B6), which gives the final image If. The coloured spots are detached on the background of the visible image. The final image If is displayed on the display means 26 at the time t=texp+Lt (block B7). The time Lt elapsing between the formation of the gamma image Ig and the display of the final image If is very short, it is dependent on the performances of the processing means used and the camera exposure time: it is typically between a few milliseconds and a few seconds.

The gamma imaging device according to the invention may then capture a further gamma radiation Rγ and substantially simultaneously a further visible light image Iv of the same observed scene. The refresh time between the formation of two successive gamma images is between approximately 0.04 seconds and 5 seconds.

The guide mode will now be described with reference to FIG. 4B.

At the start time (t=0), the auxiliary camera captures an visible light image Iv (block 311) of the observed scene and substantially simultaneously the gamma camera captures a gamma radiation Rγ (block B12) from one or a plurality of irradiant sources situated in the same observed scene.

This gamma radiation Rγ will serve to form a gamma image Ig (block B13), but this gamma image Ig is only formed on the detector after a time texp corresponding to the detector exposure time. This exposure time texp varies, for example, between 0.04 seconds and 5 seconds, preferentially between 0.8 seconds and slightly more than 2 seconds.

The gamma image Ig formed will be processed (block B14). It is divided into one or a plurality of basic zones zb provided with pixels. Each of the basic zones zb is assigned at least one indicator I1 conveying the quantity of signal present in each of the pixels of the basic zone zb. For this, it is possible to perform an arithmetic analysis and the indicator I1 may be the arithmetic mean of the level of each of the pixels of the basic zone zb. Further indicators could be used such as the variation of the arithmetic mean or further statistical indicators such as the mean or other fractile, standard deviation, etc.

Among the basic zones zb, one or a plurality of effective zones zu for which the indicator I1 is greater than a threshold S1 is then determined. The effective zones zu give a representation R of the irradiant sources. It is then possible to overlay, on the visible light image Iv, the representation R.

In an alternative embodiment, each effective zone zu may be cropped to show the outline C of each effective zone zu of the gamma image Ig. The outline of the effective zones zu gives the representation of the irradiant sources. In this case, on the visible light image Iv, only the outline C of the effective zones zu of the gamma image Ig is overlaid. In both cases, the effective zones zu or the outline of the effective zones produce a representation R of the irradiant sources observed.

The representation R is overlaid on the visible light image Iv (block B6), this produces the final image If.

The final image If is displayed on the display means 26 at the time t=texp+Lt (block B7). The time Lt elapsing between the formation of the gamma image Ig and the display of the final image If is very short. It is dependent on the performances of the processing means used and the camera exposure time, it is typically between a few milliseconds and a few seconds.

The number of basic zones zb, the geometric shape thereof and the threshold S1 are adjustable and selected by an operator operating the imaging device according to the invention. The geometric shape is preferably polygonal. The effective zones zu are those generating the most intense irradiation.

With reference to FIG. 4C, the composite mode will now be described. At the start time (t=0), the auxiliary camera captures a visible light image Iv (block B21) of the observed scene and substantially simultaneously the gamma camera captures a gamma radiation Rγ (block B22) from one or a plurality of irradiant sources situated in the same observed scene. This gamma radiation Rγ will serve to form a gamma image Ig (block B23), but this gamma image Ig is only formed after a time texp corresponding to the detector exposure time.

This exposure time texp varies, for example, between 0.04 seconds and 5 seconds, preferentially between 0.8 seconds and slightly more than 2 seconds.

The gamma image Ig formed will be processed (block B24). It is divided into one or a plurality of basic zones zb provided with pixels. Each of the basic zones zb is assigned at least one indicator 12 conveying the quantity of signal present in each of the pixels of the basic zone zb. For this, it is possible to perform an arithmetic analysis and the indicator 12 may be the arithmetic mean of the level of each of the pixels of the basic zone zb. Further indicators could be used such as the median or other fractiles, the variance, or the progression of said indicators over time. Among the basic zones zb, one or a plurality of effective zones zu for which the indicator 12 is less than a threshold S2 and one or a plurality of effective zones zu for which the indicator S2 are then determined. The pixels of the neutral zones zn are then assigned a zero level. Thresholding is then performed at one or a plurality of thresholds of the neutral zones zn and effective zones zu followed by colouring based on the thresholds. Filtering may be envisaged prior to thresholding. The effective zones zu and the neutral zones zn produce after thresholding and colouring the representation R of the irradiant sources (block B25).

The representation R is overlaid on the visible light image Iv (block B26), which gives the final image If.

The final image If is displayed on the display means 21 at the time t=texp+Δt (block B27). The irradiant sources appear as coloured spots on the visible image. The time Δt elapsing between the formation of the gamma image Ig and the display of the final image If is very short. It is dependent on the performances of the processing means used and the camera exposure time, it is typically between a few milliseconds and a few seconds.

The gamma imaging device according to the invention may then capture a further gamma radiation and substantially simultaneously a further visible light image Iv of the same observed scene. The refresh time between the capture of two successive gamma images is between approximately 0.04 seconds and 5 seconds.

The number of basic zones zb, the geometric shape thereof and the threshold S1 are adjustable and selected by an operation operating the imaging device according to the invention. The geometric shape is preferably polygonal. The effective zones zu are those generating the most intense irradiation.

In the invention, the imaging device makes it possible to capture, at the same time, a gamma radiation generating a gamma image and a visible light image in the same observed scene.

In the prior art, it was not possible to observe the scene with the same direction of sight in that the gamma camera and the auxiliary camera were axially offset in relation to the other or there was a reflecting mirror. When the gamma camera operated in visible mode and in gamma mode, the visible image and the gamma radiation producing the gamma image were not captured simultaneously.

The gamma imaging device according to the invention thus enables real-time localisation of the irradiant sources while moving the gamma camera and auxiliary camera assembly. It is thus possible to obtain a visible light image of the observed scene whereon the irradiant source detected is framed. In an alternative embodiment, it is possible to obtain a visible light image of the observed scene a representation of the irradiant sources detected is overlaid. A further embodiment consists of aiming at a specific point of the observed scene and making a longer measurement.

The benefit of this longer measurement is the accumulation of images giving rise to superior measurement statistics. This mode involves slower refreshing of the final image since it is linked with the number of images accumulated. The number of images accumulated may be optionally predetermined.

If a collimated spectrometry probe is provided in the gamma imaging device according to the invention, it is possible to obtain a quantification of the irradiant sources detected. However, this quantification is obtained in offline mode.

Although a number of embodiments of the present invention have been represented and described in detail, it will be understood that various changes and modifications may be made without leaving the scope of the invention.

### CITED DOCUMENTS

[1] FR-A-2 734 372
[2] “The development and improvement of the Aladin gamma camera to localize gamma activity in nuclear activities”, C. Le Goaller et al., European Commission,
Nuclear science and technology, EUR18230, 1998.
[3] “On site nuclear video imaging”, C. Le Goaller et al., Waste Management 1998, Tucson, USA, February 1998.
[4] “Imaging systems: new techniques for decommissioning”, C. Mahé et al., ANS 2005, Denver, USA, August 2005.
[5] “Recent progress in low-level gamma imaging”, C. Mahé et al., ICEM 2007, Bruges, Belgium, September 2007.
[6] WO 2006/090035
[7] “Gamma imaging: recent achievements and on-going developments”, Le Goaller et al., European Nuclear Conference 2005, Versailles, France, December 2005.
[8] “First experimental tests with a CdTe photon counting pixel detector hybridized with a Medipix2 readout chip”, O. Gal et al., IEEE 2003, Nuclear Science Symposium Conference Record, September 2007.

1-14. (canceled)

15. A gamma imaging device comprising:
a gamma camera that captures a gamma radiation image of an observed scene, including a front face and having an axis of sight; and
an auxiliary camera that captures a visible light image of the observed scene,
wherein the auxiliary camera is situated upstream from the front face of the gamma camera which is a pinhole collimator gamma camera, the auxiliary camera having an optical axis substantially merged with the axis of sight of the gamma camera such that the visible light image and the gamma image are captured substantially simultaneously with the same direction of sight and irradiant sources at a distance of tens of centimeters to tens of meters from the gamma camera can be localized.

16. A gamma imaging device according to claim 15, further comprising acquisition and processing means of signals output by the auxiliary camera and by the gamma camera for supplying, substantially in real time in relation to the capture, to a display, a final image of the observed scene which is an overlay of the visible light image and a representation of one or a plurality of irradiant sources situated in the observed scene and detected on the captured gamma image.

17. A gamma imaging device according to claim 16, wherein the representation is a colored spot or an outline.

18. A gamma imaging device according to claim 15, wherein the auxiliary camera is mounted on a supporting member that is attached to the front of the gamma camera, or is screwed, or by fitting.

19. A gamma imaging device according to claim 18, wherein the supporting member is substantially a revolving cylinder and has an outer diameter greater than the outer diameter of the gamma camera to enable screwing or fitting.

20. A gamma imaging device according to claim 18, wherein the supporting member is made of a material opaque to visible light, to prevent the light from entering inside the gamma camera.

21. A gamma imaging device according to claim 18, wherein the supporting member is made of a material having a sufficiently low density, or aluminum, or a plastic, to attenuate the gamma radiation from the observed scene as little as possible.

22. A gamma imaging device according to claim 15, further comprising a collimated spectrometry probe rigidly connected to the supporting member and/or the gamma camera.

23. A gamma imaging device according to claim 15, further comprising an optionally removable shutter at the front face of the gamma camera.

24. A gamma imaging device according to claim 15, wherein the gamma camera is configured to provide a visible light image of the observed scene, the visible light images from the gamma camera and the auxiliary camera are realigned with respect to each other.

25. A method for localizing one or a plurality of irradiant sources present in a scene observed by a gamma imaging device according to claim 16, comprising:
substantially simultaneous capturing, with the same direction of sight, gamma irradiation from the irradiant sources by the gamma camera and a visible light image of the scene observed by the auxiliary camera, the auxiliary camera being situated upstream from the gamma camera, the optical axis thereof merging substantially with the axis of sight of the gamma camera;
formation of a gamma image of the observed scene using the gamma radiation captured;
processing of the gamma image giving rise to a representation of the irradiant sources with:
division of the gamma image into one or a plurality of basic zones of pixels;
allocation of at least one indicator to each basic zone, this indicator conveying a basic zone signal quantity;
determination among the basic zones of one or a plurality of effective zones for which the indicator is greater than a threshold;
optionally, cropping of the effective zones to show an outline of the effective zones, the effective zones or the outline of the effective zones giving the representation;
overlay of the visible light image and the representation to obtain a final image of the observed scene;
display of the final image.

26. A method for localizing at least one irradiant source according to claim 25, wherein the processing further comprises:
determination among the basic zones of one or a plurality of neutral zones for which the indicator is less than the threshold;
allocation of a zero level to neutral zone pixels;
thresholding at one or a plurality of thresholds and coloring on the basis of the thresholds of the neutral and effective zones, the neutral and effective zones after thresholding and coloring giving the representation.

27. A method for localizing according to claim 25, wherein the thresholding is preceded by filtering.

28. A method for localizing according to claim 25, wherein the indicator is a mean level of pixels of the basic zone.
